(19) United States
(12) Patent Application Publication
(10) Pub. No.: US 2009/0238355 A1
(43) Pub. Date: Sep. 24, 2009

(54) GUIDED ASSIGNMENT OF TELEPHONE FEATURES

(75) Inventors: Donald J. Culeton, Victor, NY (US); Jason M. Ingalsbe, Rochester, NY (US); Stephen G. Kosarko, Victor, NY (US); Mark R. Rissberger, North Chili, NY (US)

Correspondence Address: Stephen B. Salai, Esq.;Harter Secrest & Emery LLP, 1600 Bausch & Lomb Place, Rochester, NY, 14604-2711, US

(73) Assignee: INFO DIRECTIONS, INC., Victor, NY (US)

(21) Appl. No.: 12/052,351

(22) Filed: Mar. 20, 2008

(51) Int. Cl. H04M 3/42

(52) U.S. Cl. 379/201.12

(57) ABSTRACT

A method of offering telephone services to a customer includes displaying a product catalog containing at least one guided assignment folder in response to determining the presence of a root folder. The method also includes governing an evaluation of a plurality of content contained in the at least one guided assignment folder based on a rule set. The rule set is unique to a folder type associated with the at least one guided assignment folder. The method also includes forming a telephone service order including a content of the plurality of content automatically assigned to the service order based on the rule set.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present invention relates to a system and method for providing telephone services and, in particular, to a system and method for guiding the assignment of features and other retail products to telephone services.

2. Description of Related Art

The use of wireless telephone services in the United States has grown steadily over the last few years as the offerings, services, and prices of wireless telephones and other wireless components have become more attractive. The rapid growth in the wireless telephone industry has forced service providers to expand both their service offerings and the features offered with each type of service.

Telephone service customers typically prefer to have a great deal of flexibility in selecting the features assigned to their service. Offering such flexibility, however, can present problems for service providers and for the customers themselves. For instance, due to the multitude of different features compatible with some types of telephone services and due to customers wishing to customize their telephone service with features of their choosing, it can be confusing and difficult to navigate through the series of steps required to assign such features with known order entry software. This difficulty may stem from the shear number of options available. Such difficulty may also arise if the service provider's order entry system is not configured to easily and efficiently guide customers through the order entry/telephone service modification process.

Accordingly, the disclosed systems and methods are directed towards overcoming one or more of the problems set forth above.

### SUMMARY OF THE INVENTION

In an exemplary embodiment of the present disclosure, a method of offering telephone services to a customer includes displaying a product catalog containing at least one guided assignment folder in response to determining the presence of a root folder. The method also includes governing an evaluation of a plurality of content contained in the at least one guided assignment folder based on a rule set. The rule set being unique to a folder type associated with the at least one guided assignment folder. The method further includes forming a telephone service order including a content of the plurality of content automatically assigned to the service order based on the rule set.

In an additional exemplary embodiment of the present disclosure, a method of offering telephone services to a customer includes collecting a plurality of customer information, determining that a root folder exists, and displaying a product catalog associated with the root folder. The product catalog contains a plurality of guided assignment folders. The method also includes determining a type and contents of at least one guided assignment folder of the plurality of guided assignment folders. The method also includes receiving a selection of desired features from the customer and automatically assigning at least one feature to a telephone service of the customer.

### BRIEF DESCRIPTION OF THE DRAWINGS

FIG. 1 is a diagrammatic illustration of a telephone service system according to an exemplary embodiment of the present disclosure.

FIG. 2 is a flow chart illustrating a method of providing telephone services according to an exemplary embodiment of the present disclosure.

FIG. 3 is a diagram illustrating a portion of the method illustrated in FIG. 2.

FIG. 4 illustrates a guided assignment wizard according to an exemplary embodiment of the present disclosure.

FIG. 5 illustrates another guided assignment wizard according to an exemplary embodiment of the present disclosure.

FIG. 6 illustrates still another guided assignment wizard according to an exemplary embodiment of the present disclosure.

FIG. 7 illustrates a further guided assignment wizard according to an exemplary embodiment of the present disclosure.

FIG. 8 illustrates still another guided assignment wizard according to an exemplary embodiment of the present disclosure.

FIG. 9 illustrates yet another guided assignment wizard according to an exemplary embodiment of the present disclosure.

### DETAILED DESCRIPTION OF THE DRAWINGS

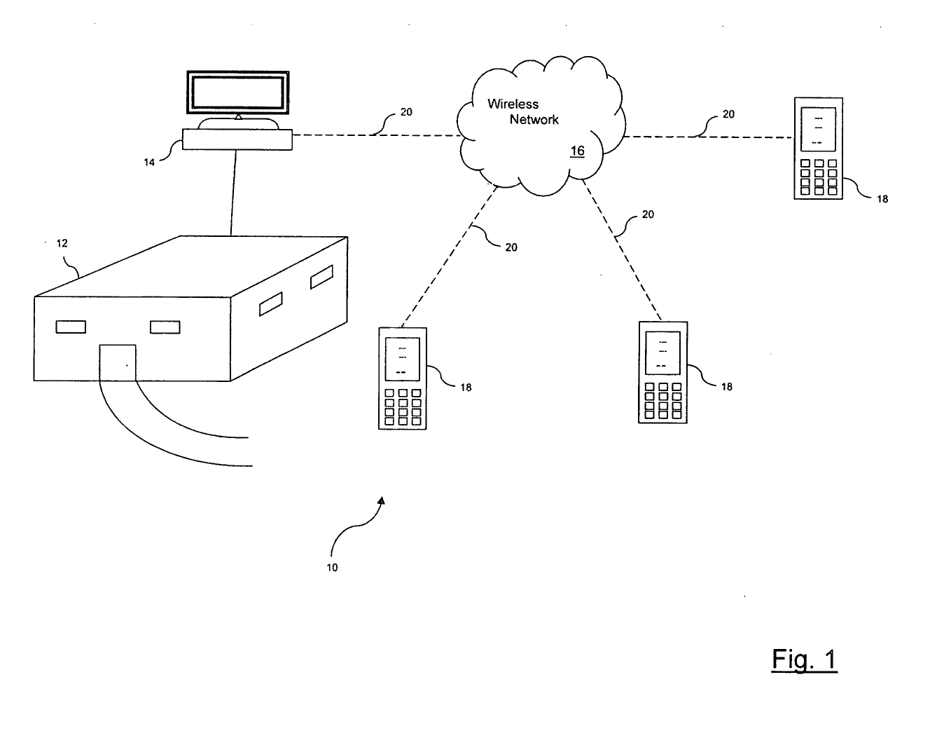

FIG. 1 illustrates a telephone service system 10 according to an exemplary embodiment of the present disclosure. As shown in FIG. 1, the system 10 can include, for example, a server 14 connected to a wireless network 16. The system 10 can also include one or more mobile devices 18 connected to the wireless network 16. One or more components of the system 10 may be housed in and/or otherwise located within a sale center 12. For example, the server 14 may be located within the sale center 12 and may be connected to the wireless network 16 via one or more connections 20.

The sale center 12 may be, for example, any type of retail store known in the art, such as a brick and mortar retail store. The sale center 12 may also be, for example, a store front accessible by wireless telephone service customers, a kiosk located within a shopping mall, a stand-alone shopping facility, and/or any other known retail facility. In addition, the sale center 12 may be a call center, a website operated by the service provider, and/or any other conventional point of sale known in the art. In an exemplary embodiment of the present disclosure, telephone service customers may be required to visit the sale center 12 to, for example, select equipment for use, select service plans and/or add-on features, make advanced payments, receive wireless equipment, activate their telephone service, replenish their service, and/or otherwise make any transactions necessary for the activation or replenishment of such features and/or services. As used herein, the term “customer” may identify the individual purchasing goods or services such as, for example, mobile devices 18, accessories, and/or service contracts from the service provider. As also used herein, the term “user” may identify the individual entering information into and/or otherwise interfacing with the telephone service system 10. Generally, the user is a sales representative of the service provider and the terms “sales representative” and “user” may be used interchangeably throughout the present disclosure. It is also understood that, in an exemplary embodiment of the present disclosure, a user may be a customer.

It is understood that the embodiment of the sale center 12 utilized by the service provider may be dependent upon various factors including, but not limited to, the service provider's business model. For example, the service provider's business model may be such that customers are required to visit a brick and mortar sale center 12 in-person to select a mobile device 18, make an advance payment, and/or otherwise activate their service. However, the service provider may allow the customer to replenish their service via credit card by either calling a service provider customer service department or by visiting a service provider website. In such an exemplary embodiment, the sale center 12 may include the brick and mortar sale center, the customer service department, and the website.

The server 14 can comprise, for example, an electronic control unit, a computer, and/or any other electrical control device known in the art. The server 14 can include one or more operator interfaces such as, for example, a monitor, a keyboard, a mouse, a touch-screen, and/or any other devices useful in entering, reading, storing, and/or extracting data from a human user or from one or more devices to which the server 14 is connected. The server 14 can also be configured to store and/or manipulate data regarding, for example, telephone services or customers, as well as data collected from the customer or from the mobile device 18 associated with the customer. Such data can include, for example, name, address, social security number, and/or other customer information. Such data can also include account number, service address, service type, username, password, account balance, duration of service, and/or other account information. The collected data can, for example, be stored by one or more memory devices of the server 14 and can be manipulated by the server 14 as desired.

As shown in FIG. 1, the server 14 can be connected to the wireless network 16 via one or more connections 20. The connections 20 can consist of any conventional electrical and/or communication means known in the art such as, for example, wires or other like connection structures, as well as wireless communication means. The connections 20 may provide customers with a variety of options for communication. For example, the connections 20 may be configured to transmit and receive multimedia communications including, for example, audio, voice, video, text, imaging, and all other types of data. Such data can be transmitted between the wireless network 16 and the server 14 and may also be transmitted between the wireless network 16 and the mobile device 18.

The wireless network 16 may comprise, for example, one or more data networks such as, the internet, and/or public telephone networks including wireless networks. In an exemplary embodiment, the wireless network 16 may comprise an internet protocol (“IP”) network, including a data link.

The mobile devices 18 shown in FIG. 1 can include, for example, cellular telephones, hand-held computers, personal data organizers, and/or any other mobile devices known in the art. The mobile devices 18 may be configured to receive and/or transmit any kind of communications data known in the art such as, for example, audio, voice, video, text, imaging, and/or other types of data. The mobile devices 18 may be configured to send and receive, for example, text messages, email, digital images, voice communications, and/or any other electrical or digital information known in the art. Such mobile devices 18 may be produced by any known mobile device manufacturer and may be electrically, wirelessly, and/or otherwise connectible to the wireless network 16.

It is understood that the exemplary system 10 illustrated in FIG. 1 may include additional components configured to facilitate wireless, electrical, and/or other connections between, for example, the mobile devices 18, the wireless network 16, and the server 14. Such components may include any electrical, telecommunications, and/or other components known in the art.

### INDUSTRIAL APPLICABILITY

Telephone services facilitated and/or otherwise provided by the exemplary telephone service system 10 of the present disclosure can be purchased at a sale center 12 and activated on the spot. In an exemplary embodiment, a customer may visit the sale center 12, and may elect to purchase a mobile device 18 and any associated mobile telephone services or add-on features. Alternatively, upon visiting the sale center 12, the customer may activate telephone services on an existing mobile device 18 already owned by the customer. As will be discussed in greater detail below, exemplary embodiments of the present disclosure may be utilized in guiding the customer and/or the user through a process in which one or more features are associated with and/or otherwise assigned to the selected telephone service. Such features may be assigned to the telephone service automatically and/or manually.

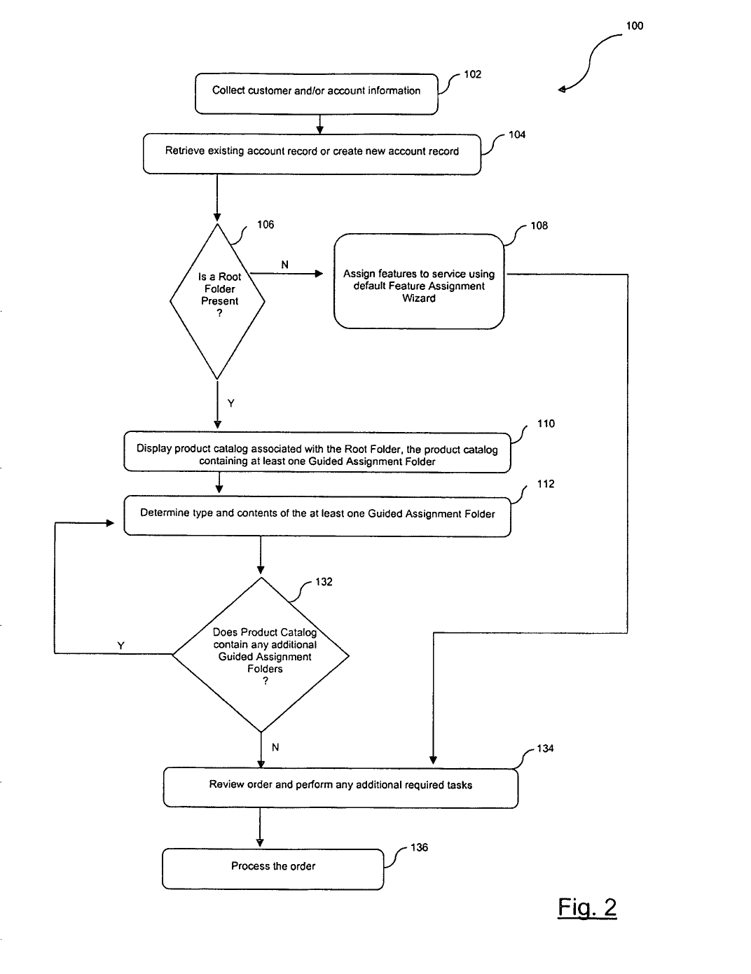

FIG. 2 depicts a flow chart 100 illustrating a method of offering telephone services to a customer according to an exemplary embodiment of the present disclosure. As a first step in this method, a sales representative of a wireless telephone service provider or other system user may collect customer and/or account information (Step 102). In some embodiments of the present disclosure, the customer may be a new customer and in alternative embodiments of the present disclosure, the customer may be an existing customer. Accordingly, the account information collected in Step 102 may be useful in either establishing a new account record for a new customer or for retrieving an existing account record for an existing customer. Such information can include, for example, the customer's full name, a company name associated with the customer, a service address, a billing address, an account type, a service start date, a billing cycle, a desired invoice format and/or any other customer and/or account information known in the art.

As shown in Step 104, the sales representative may use the collected information to retrieve an existing account record or create a new account record. Although not illustrated in FIG. 2, it is understood that the sales representative and/or the customer may, at this stage, specify any number of customer-level features to be associated with the customer. The sales representative and/or the customer may also choose the service types to be assigned to and/or otherwise associated with the customer. It is understood that multiple services of the same type can be created by specifying the quantity of services. The customer and/or the sales representative may also choose the service types to be assigned as sub-services, and multiple sub-services of the same type can be created by specifying the quantity desired. Step 104 can also include assigning service numbers, billing numbers, and/or other information to be associated with the desired services.

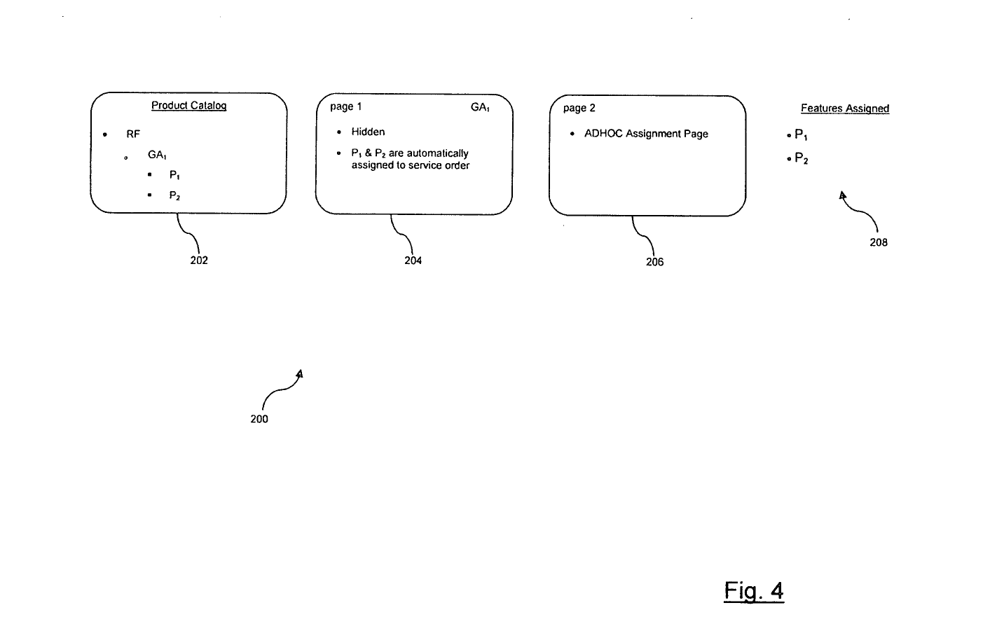

As shown in FIG. 2, in Step 106, the system 10 (FIG. 1) and/or the sales representative can determine whether or not a root folder is present. A root folder may be, for example, a starting point for the guided assignment wizard. It is understood that, although only a single root folder is illustrated in, for example, FIGS. 4-9, the guided assignment wizards described herein may include more than one root folder. The one or more root folders may contain, for example, multiple guided assignment folders of the type described herein. As FIG. 2 illustrates, if a root folder is not present, the system 10 may assign features to the customer's service using a default feature assignment wizard (Step 108).

If, however, a root folder is determined to be present, the system 10 may display a product catalog associated with the root folder (Step 110). As will be described in greater detail below, the product catalog may contain at least one guided assignment folder, and the customer may be required to select a group of services to which a common set of features will be automatically assigned. In an exemplary embodiment, the system 10 may display a list of features for the customer to choose from based on the type, contents, and/or other configurations of the guided assignment folders that are displayed. Such a list may assist the customer in selecting the features that will be automatically assigned to each of the services associated with the customer's account. In an exemplary embodiment, the list of assignable features may include any and all items included in the service provider's catalog of offerings. Such items may include, among other things, pricing plans, discounts, contracts, handsets, and accessories. Thus, the list of assignable features may include billable items, nonbillable items, physical items, and/or non-physical items.

It is also understood that, in an exemplary embodiment of the present disclosure, telephone service features and/or other content may be automatically added and/or otherwise assigned to a customer's telephone service order in response to a mobile device selection made by the customer. For example, the system 10 (FIG. 1) may be configured to offer certain features, such as internet access, to the customer based on the mobile device 18 the customer selects. In such an embodiment, the customer may be offered internet access, SMS, or other services only after selecting a mobile device 18 capable of utilizing such functionality. Alternatively, the system 10 may be configured to offer certain mobile devices or accessories to the customer based on the plan or contract the customer selects. For example, if the customer selects a two-year service plan, the system 10 may automatically select an upgraded mobile device model. Thus, the system 10 may be configured to begin the guided assignment process based on either the selection of retail items (for example, mobile devices 18 or accessories) or the selection of billing items (for example, service contracts or add-on features). In this way, the exemplary methods disclosed herein may assist the service provider in combining retail and billing functions.

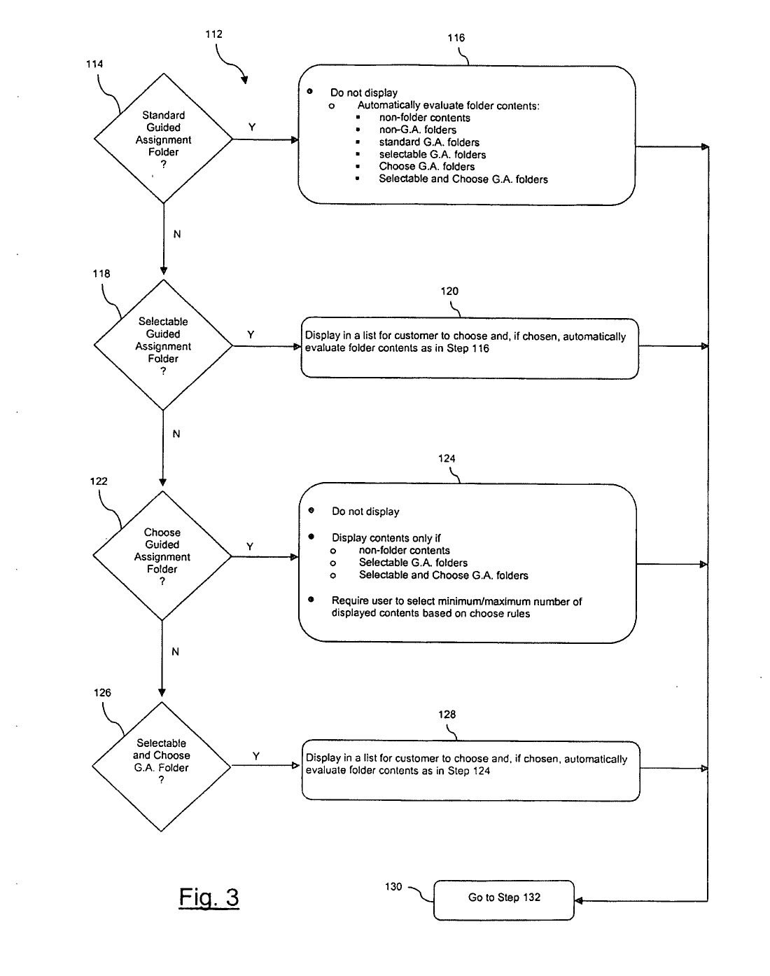

In an exemplary embodiment, the system 10 may automatically determine the type and/or contents of the at least one guided assignment folder that is displayed (Step 112). System logic may then determine the features to be assigned to the customer's service either automatically or with minimal input from the customer or user. FIG. 3 illustrates an exemplary embodiment of Step 112 in which the type and/or contents of the guided assignment folders displayed by the system 10 can be used to determine whether and/or how to assign the contents. In particular, the evaluation and/or automatic assignment of the content contained in the displayed guided assignment folders can be governed by a predetermined rule set. The predetermined rule set can be unique to, for example, a folder type associated with the guided assignment folder being displayed.

As shown in FIG. 3, the system 10 (FIG. 1) may determine if the guided assignment folder displayed is a standard guided assignment folder (Step 114). If the guided assignment folder is a standard guided assignment folder, the system 10 may not display the contents of the folder. Instead, as illustrated in the rule set 116, the system 10 may automatically evaluate the folder contents. Each of the folder contents may be evaluated and/or otherwise processed based on folder type. In particular, for a standard guided assignment folder, the system 10 may evaluate the folder's children and the evaluation may differ depending on the type of child contained within the folder. For example, for all non-folder contents or children, such as, for example, retail items, packages, products, discounts, contracts, pricing plans, and/or roaming agreements, the system 10 may automatically assign the non-folder contents to the service without user and/or customer intervention. As will be explained in greater detail below with respect to FIG. 3, the guided assignment folder displayed in Step 110 can include not only standard guided assignment folders as described above with respect to Step 114, but can also include selectable guided assignment folders, choose guided assignment folders, and selectable and choose guided assignment folders. The displayed guided assignment folder can also include standard folders (i.e., non-guided assignment folders). Such standard or non-guided assignment folders will be ignored by the system 10 during the evaluation occurring in Step 116. All selectable guided assignment folders will be displayed by the system 10 for the customer to choose from. All choose guided assignment folders will evaluate their children. For the purposes of this disclosure, “evaluating the child” of a guided assignment folder includes displaying all non-folder items and all selectable guided assignment folders in a list for the customer to choose from. In addition, selectable and choose guided assignment folders will be displayed in a list of selectable items. If such a folder is selected, the children of the selectable and choose guided assignment folder will be evaluated as discussed above with respect to the choose guided assignment folder.

As shown in FIG. 3, if the at least one guided assignment folder displayed in Step 110 is not a standard guided assignment folder, the system 10 will determine whether the at least one guided assignment folder is a selectable guided assignment folder (Step 118). If the at least one guided assignment folder is a selectable guided assignment folder, the system 10 will display the folder in a list for the customer to choose (Step 120).

If the displayed folder is chosen, the system 10 will automatically evaluate the contents of the folder as discussed above with respect to Step 116. If, however, the at least one guided assignment folder displayed in Step 110 is neither a standard guided assignment folder nor a selectable guided assignment folder, the system 10 may determine whether the at least one guided assignment folder is a choose guided assignment folder (Step 122). As shown in Step 124, a choose guided assignment folder may not be displayed in the guided assignment wizard but instead its children may be displayed and the customer may be required to select a minimum or maximum number of displayed contents based on the choose rules associated with the choose guided assignment folder. For example, a child or contents of a choose guided assignment folder may be displayed in a selection list of the choose guided assignment folder if it is one of a non-folder content, a selectable guided assignment folder, or a selectable and choose guided assignment folder.

As discussed above, the choose guided assignment folder may require the customer to select a minimum or maximum number of displayed contents based on one or more choose rules. In an exemplary embodiment, such choose rules may include the following: 1) if the minimum and maximum choose limits are the same and are not zero, the customer may be required to choose exactly that many items; 2) if the minimum and maximum amounts are zero, the customer can choose zero or more items; and 3) if the minimum amount is equal to or greater than the listed number of items or contents, the customer may be required to choose items until the minimum is met. In such an example, the system 10 may provide a warning or other notification to the user and/or the customer that the minimum choose amount was not met or that the maximum choose amount was exceeded.

As shown in FIG. 3, if the at least one guided assignment folder displayed in Step 110 is not a standard guided assignment folder, a selectable guided assignment folder, or a choose guided assignment folder, the system 10 may determine whether the at least one guided assignment folder is a selectable and choose guided assignment folder (Step 126). If the at least one guided assignment folder is a selectable and choose guided assignment folder, the system 10 may display the selectable and choose guided assignment folder in a list for the customer to choose (Step 128). If chosen, its children and/or any other folder contents may be automatically evaluated by the system 10 as discussed above with respect to Step 124.

As shown in Step 130, once the evaluation of one or more contents contained in the at least one guided assignment folder displayed in Step 110 has been evaluated based on one or more corresponding rule sets, the system 10 may determine whether the product catalog displayed in Step 110 contains any additional guided assignment folders (Step 132). If such additional guided assignment folders are present, the system 10 may determine the type and contents of the additional guided assignment folders as discussed above with respect to Step 112. If, however, the displayed product catalog does not contain any additional guided assignment folders, the user and/or customer will be given the opportunity to reconfigure the features that have been assigned to the customer's services and/or otherwise review the customer's order (Step 134).

While reviewing the order, the system 10 may also display an ADHOC assignment page. In an exemplary embodiment, the ADHOC assignment page may include a list of features that a customer may choose from for assignment to the specified services. In an exemplary embodiment, a user of the system 10 may assign individual features to a customer's service order outside of the guided assignment wizards disclosed herein using either a search function or a browse function associated with the ADHOC assignment page. Using this functionality, the user may search or browse the service provider's catalog of offerings for features that may not have appeared on the guided assignment wizard pages. For example, if a user assists a business customer using a guided assignment wizard configured for a residential customer, certain business-related features may not be included and/or displayed in the wizard. Accordingly, the user could use the ADHOC assignment page to search for and assign business-related features to the business customer's order outside of the guided assignment wizard.

The ADHOC assignment page may be useful in embodiments of the system 10 utilizing one or more folder filters. In such embodiments, folder filters may be included as a part of the guided assignment wizard to filter out or hide certain folders containing features that do not apply to a particular customer. Folders filtered out by such folder filters are not displayed during the guided assignment wizard. For example, a first folder may be tagged as applying to business customers and a second folder may be tagged as applying to residential customers. In such an exemplary embodiment, if a customer is characterized as a business customer, the active folder filter may cause the second folder to be hidden, and only the first folder may be displayed. Folders that are hidden or filtered out by the folder filters may contain features that are later added at the ADHOC assignment page. It is understood that additional filters may be used to filter out or hide folders based on, for example, geographic and/or other customer or service characteristics. It is also understood that the folder filters may be script-driven and, thus, may be more easily customizable than known data-driven filters. It is further understood that any of the folder filters discussed above may be applied to folders that are automatically evaluated during a guided assignment wizard and these filters are not limited to folders that are selectable by the user or the customer.

During Step 134, the customer and/or the user may be given the opportunity to perform any additional required tasks associated with completing an order for telephone services. For example, such additional tasks may include adding more features to the customer's account record, adding more services to the customer's account record, and/or other known tasks associated with completing the order. The user and/or the customer will then be given the opportunity to submit the order after which it will be processed according to ordinary business practices of the service provider (Step 136).

FIGS. 4-9 illustrate the user/customer experience in a guided assignment wizard starting at a root folder in a product catalog. The guided assignment wizard is illustrated in the pages of the product catalog shown in FIGS. 4-9 and the features assigned to the telephone services upon completion of the guided assignment wizard are illustrated in the “Features Assigned” section of FIGS. 4-9. For each of the cases illustrated in FIGS. 4-9, the following assumptions have been made: 1) the children and/or contents of each assigned folder are also assigned (these children have been omitted for simplicity); 2) the sort order is the order in which the contents appear in the product catalog box unless otherwise stated; 3) there are no choose packages configured; and 4) choose folders (i.e., choose guided assignment folders and selectable and choose guided assignment folders) are all “choose 1 folders” unless stated otherwise.

The guided assignment wizard 200 shown in FIG. 4, illustrates that any features/contents in a guided assignment type folder will automatically be evaluated. As shown in FIG. 4, the product catalog 202 contains a root folder (RF) having a guided assignment folder (GA₁), and the guided assignment folder contains two products (P₁, P₂). In such an exemplary embodiment, the products P₁, P₂ may be automatically assigned to the service and the customer does not need to interact with the guided assignment wizard. In particular, as shown in page 1 of the guided assignment wizard (Box 204), the standard guided assignment folder GA₁ will be hidden and the telephone service features/products P₁, P₂ are automatically assigned to the customer's service order. As shown at page 2 (Box 206) of the guided assignment wizard, the ADHOC assignment page will be displayed by the system 10 (FIG. 1). The products P₁, P₂ are the features assigned 208 to the service order.

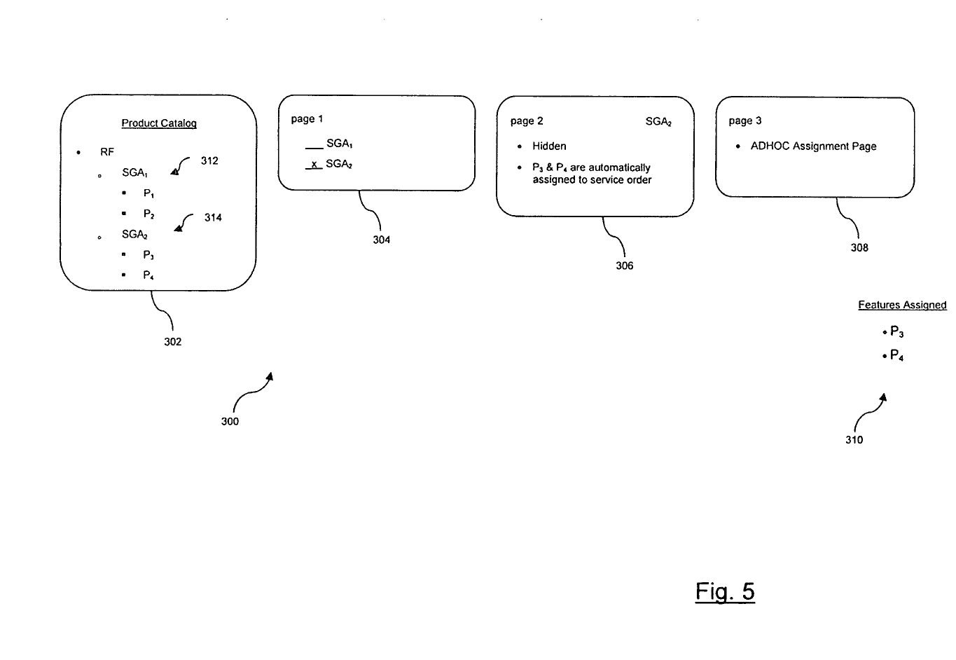

FIG. 5 illustrates an exemplary use of a selectable guided assignment folder. In the guided assignment wizard 300 illustrated in FIG. 5, the product catalog 302 contains a root folder, and the root folder includes two selectable guided assignment folders (SGA₁, SGA₂). The children/contents 312 of the first selectable guided assignment folder SGA₁ are telephone service features/products P₁, P₂ and the children/contents 314 of the second selectable guided assignment folder SGA₂ are the products P₃, P₄. As shown in page 1 of the guided assignment wizard (Box 304), the customer can be given the option of choosing at least one of the selectable guided assignment folders. Once the desired selectable guided assignment folder has been chosen (SGA₂), its children will be evaluated. As shown in page 2 of the guided assignment wizard (Box 306), the second selectable guided assignment folder will be hidden and its children P₃, P₄ can be automatically assigned to the service order. In page 3 of the guided assignment wizard (Box 308), the ADHOC assignment page can be shown. The features assigned 310 in the exemplary guided assignment wizard 300 of FIG. 5 will be the contents of the chosen selectable guided assignment folder (features P₃, P₄).

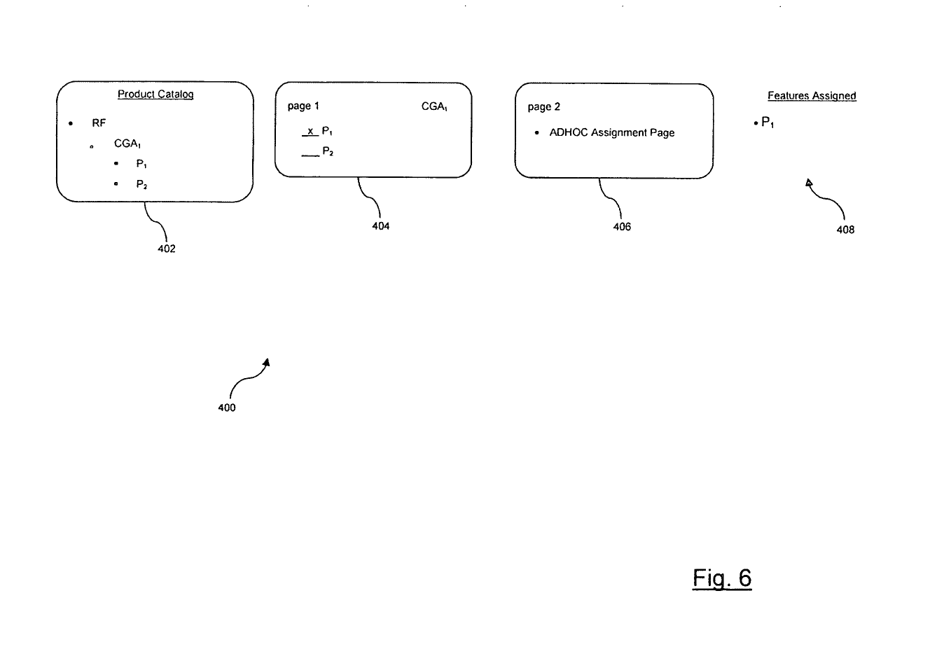

FIG. 6 illustrates an exemplary guided assignment wizard 400 in which a product catalog 402 contains a choose guided assignment folder (CGA₁). As shown in page 1 of the guided assignment wizard (Box 404), the choose guided assignment folder (CGA₁) will not be displayed but each of its children (P₁, P₂) will be listed for selection. The customer may then be given the opportunity to select at least one of the telephone service features/products. As shown in page 2 of the guided assignment wizard (Box 404), the customer has selected the product Pi, and after making such a selection, the ADHOC assignment page will be displayed at page 2 of the guided assignment wizard (Box 406). As shown in FIG. 6, such actions by the customer will result in the features assigned 408 being P₁.

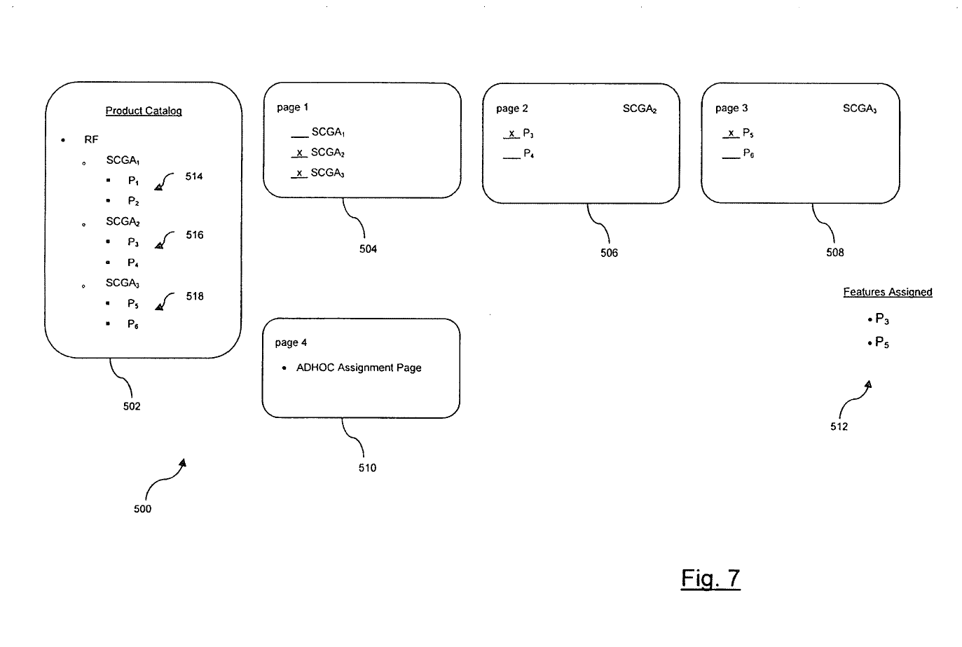

FIG. 7 illustrates an exemplary guided assignment wizard 500 in which the product catalog 502 contains three selectable and choose guided assignment folders (SCGA₁, SCGA₂, SCGA₃). In addition, each of the selectable and choose guided assignment folders in the product catalog 502 contain a plurality of children 514, 516, 518. As discussed above with respect to FIG. 3, selectable and choose guided assignment folders are a combination of select guided assignment folders and choose guided assignment folders. For example, selectable and choose guided assignment folders are displayed as selectable guided assignment folders and the contents selected are evaluated like contents of a choose guided assignment folder. In addition, children of selectable and choose guided assignment folders are listed as selectable items. Accordingly, selectable and choose guided assignment folders enable the bundling of certain features with telephone services and/or other items that have been previously selected by the customer.

As shown in the exemplary guided assignment wizard 500 of FIG. 7, each of the selectable and choose guided assignment folders may be displayed at page 1 (Box 504). Since there is no parent choose guided assignment folder in the product catalog 502, the customer can choose 1, 2, or all 3 of the selectable and choose guided assignment folders shown in Box 504. Alternatively, the customer may have the option of choosing none of the displayed selectable and choose guided assignment folders. As shown in FIG. 7, the customer has chosen the second and third selectable and choose guided assignment folders (SCGA₂, SCGA₃), and each of the chosen selectable and choose guided assignment folders will be evaluated at pages 2 and 3 of the guided assignment wizard 500. In this example, the customer has chosen P₃ of SCGA₂ at Box 506, and P₅ of SCGA₃ at Box 508. The system 10 may then display the ADHOC assignment page (Box 510) at page 4 of the guided assignment wizard 500. The system 10 may then display the features assigned 512 (P₃, P₅).

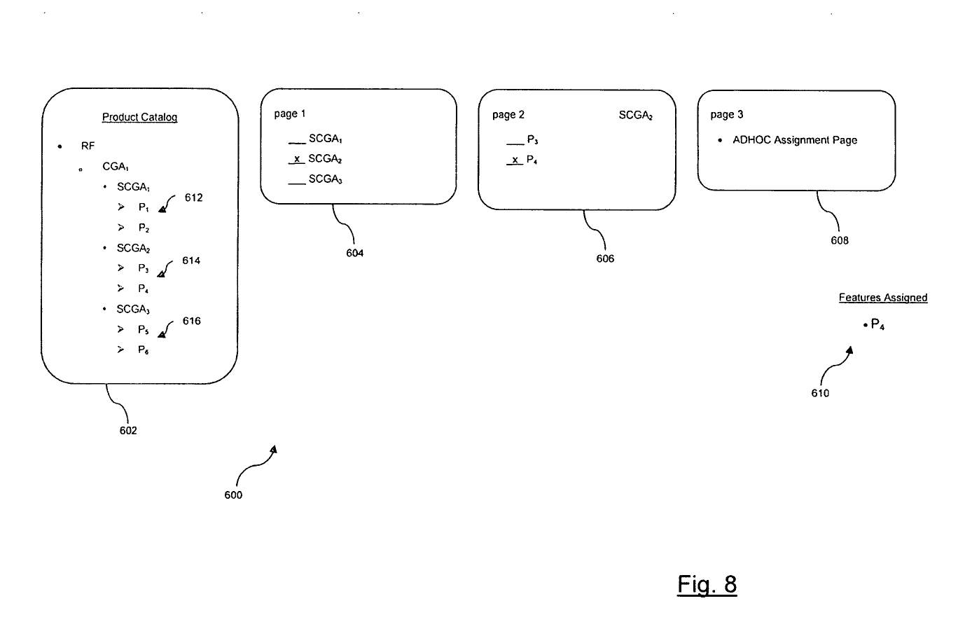

FIG. 8 illustrates an exemplary guided assignment wizard 600 of the present disclosure in which the product catalog 602 includes a choose guided assignment folder (CGA₁) as a parent folder of three selectable and choose guided assignment folders (SCGA₁, SCGA₂, SCGA₃). In addition, each of the child selectable and choose guided assignment folders include a plurality of contents and/or children (612, 614, 616). Assuming that the choose guided assignment folder of the product catalog 602 (CGA₁) is a “choose one folder,” the customer will be required to select one item from the list of selectable and choose guided assignment folders displayed at page 1 (Box 604) of the guided assignment wizard 600. For example, upon selecting the second selectable and choose guided assignment folder (SCGA₂) the children of the second selectable and choose guided assignment folder may be displayed at page 2 (Box 606). As illustrated in FIG. 8, the customer has chosen product P₄. After making a selection at page 2, the ADHOC assignment page 608 will be displayed by the system 10 at page 3 of the guided assignment wizard 600. Finally, the selected features to be assigned 610 will be displayed by the system 10. As shown in FIG. 8, the only feature to be assigned in this exemplary embodiment is feature/product P₄.

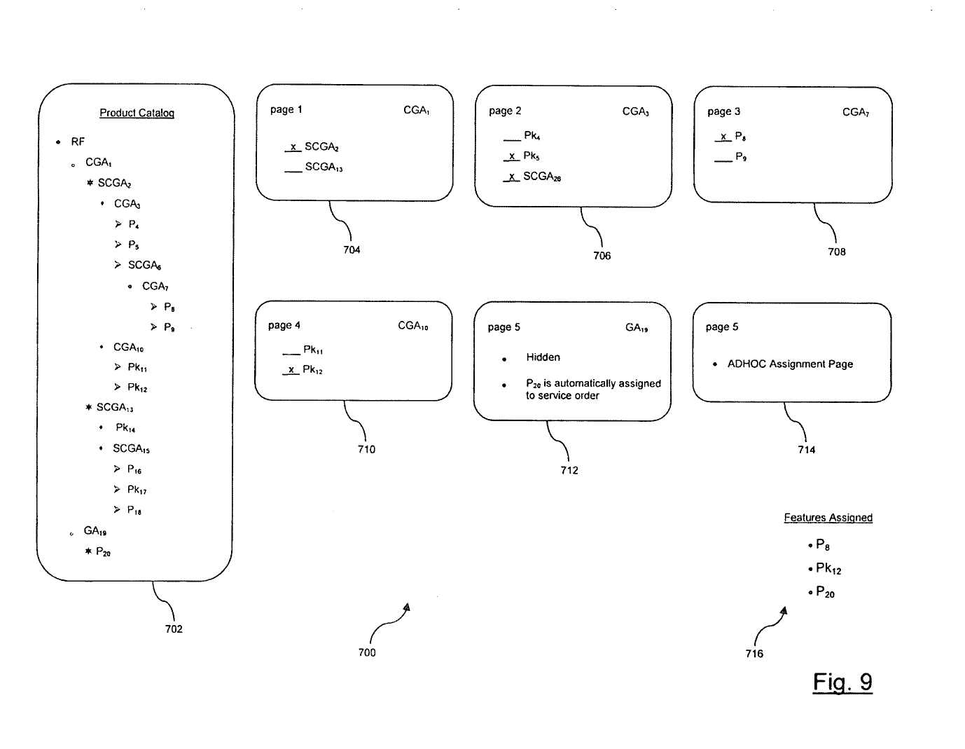

FIG. 9 illustrates an additional exemplary embodiment of the present disclosure in which a guided assignment wizard 700 includes a product catalog 702 having a choose guided assignment folder (CGA₁) as a parent. Upon determining the parent folder to be a choose guided assignment folder, the system 10 will list each child of the choose guided assignment folder (CGA₁) at page 1 (Box 704) of the guided assignment wizard 700. Since the children of the choose guided assignment folder (CGA₁) are selectable and choose guided assignment folders (SCGA₂, SCGA₁₃), each of the children are listed as items to select. As shown on page 1, the customer has selected SCGA₂, and accordingly, the children of the chosen selectable and choose guided assignment folder SCGA₂ will be evaluated according to the predetermined rule set. In this example, the children of the selected selectable and choose folder SCGA₂ are choose folders (CGA₃, CGA₁₀). At page 2 (Box 706) of the guided assignment wizard 700, the customer has selected a selectable and choose guided assignment folder (SCGA₆) from among the children of CGA₃. As a result of this selection, the system 10 will evaluate the only child of SCGA₆, which is the choose guided assignment folder CGA₇. As shown on page 3 (Box 708) of the guided assignment wizard 700, the customer has chosen feature/product P₈ contained within the choose guided assignment folder CGA₇.

Once this selection has been made, the other child (CGA₁₀) of selectable and choose guided assignment folder SCGA₂ will be evaluated by the customer. As shown in box 710, the customer has selected feature/package Pk₁₂ contained therein. It is understood that in each of the embodiments discussed above, more than one type of guided assignment folder can be utilized in a single guided assignment wizard. For example, as shown in Box 702, the exemplary guided assignment wizard 700 can also include a standard guided assignment folder GA₁₉. After determining that the folder GA₁₉ is a standard guided assignment folder, the system 10 may not display the contents of the folder GA₁₉ and may automatically evaluate its contents. The product P₂₀ may, thus, be automatically assigned to the service order without customer intervention (Box 712). An ADHOC assignment page will then be shown at page 5 (Box 714) of the exemplary guided assignment wizard 700, and the features assigned 716 as a result of the evaluation discussed above will be features/products P₈, Pk₁₂, and P₂₀.

Other embodiments of the disclosed system 10 will be apparent to those skilled in the art from consideration of this specification. It is intended that the specification and examples be considered as exemplary only, with the true scope of the invention being indicated by the following claims.

What is claimed is:

1. A method of offering telephone services to a customer, comprising:
displaying a product catalog containing at least one guided assignment folder in response to determining the presence of a root folder;
governing an evaluation of a plurality of content contained in the at least one guided assignment folder based on a rule set, the rule set being unique to a folder type associated with the at least one guided assignment folder; and
forming a telephone service order including a content of the plurality of content automatically assigned to the service order based on the rule set.

2. The method of claim 1, further including retrieving an existing account record associated with the customer.

3. The method of claim 1, wherein the plurality of content comprises features of the telephone service.

4. The method of claim 1, wherein governing the evaluation of the plurality of content comprises prompting the customer to make a content choice.

5. The method of claim 1, wherein the rule set comprises a folder display sequence.

6. The method of claim 1, wherein the folder type is one of a standard guided assignment folder, a selectable guided assignment folder, a choose guided assignment folder, and a selectable and choose guided assignment folder.

7. The method of claim 1, further including governing an evaluation of an additional plurality of content contained in at least one sub-folder of the at least one guided assignment folder based on the rule set.

8. The method of claim 1, wherein governing the evaluation of the plurality of content comprises automatically adding the content of the plurality of content to the telephone service order in response to a mobile device selection made by the customer.

9. The method of claim 1, wherein governing the evaluation of the plurality of content comprises regulating at least one of a minimum and a maximum number of content the customer must choose.

10. The method of claim 1, wherein the product catalog contains a plurality of guided assignment folders, the method further including prompting the customer to choose from the plurality.

11. The method of claim 10, further including automatically evaluating the plurality of content in response to the customer choosing the at least one guided assignment folder.

12. The method of claim 1, wherein governing the evaluation of the plurality of content comprises
prompting the customer to choose the at least one guided assignment folder from among a plurality of displayed folders, and
prompting the customer to choose the content from the plurality of content, the plurality of content being contained within the at least one guided assignment folder.

13. The method of claim 1, wherein forming the telephone service order includes merging a first order entry flow with a second order entry flow.

14. The method of claim 1, further including hiding an additional guided assignment folder based on a filter.

15. The method of claim 14, further including automatically evaluating a content of the additional guided assignment folder.

16. The method of claim 1, further including adding a feature to the telephone service order that was not included in the plurality of content.

17. A method of offering telephone services to a customer, comprising:
collecting a plurality of customer information;
determining that a root folder exists;
displaying a product catalog associated with the root folder, the product catalog containing a plurality of guided assignment folders;
determining a type and contents of at least one guided assignment folder of the plurality of guided assignment folders;
receiving a selection of desired features from the customer; and
automatically assigning at least one feature to a telephone service of the customer.

18. The method of claim 17, further comprising displaying the plurality of guided assignment folders.

19. The method of claim 17, wherein an order entry flow of the at least one guided assignment folder is governed by a rule set, the rule set being unique to the determined type of the at least one guided assignment folder.
